(19) United States
(12) Patent Application Publication
(10) Pub. No.: US 2008/0177509 A1
(43) Pub. Date: Jul. 24, 2008

(54) Method of Determining the State of a Body

(75) Inventor: Christian Zecha, Groebenzell (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 12/016,732

(22) Filed: Jan. 18, 2008

(30) Foreign Application Priority Data
Jan. 18, 2007 (DE) 10 2007 002 672.4

(51) Int. Cl. G06F 17/18; G01C 21/00

(52) U.S. Cl. 702/194; 701/214; 702/197; 702/199

(57) ABSTRACT

In a process and apparatus for determining the state of a body, a number n of measured values \vec{x}ᵢ of a state of the body with i=1, . . . , n are measured and recorded, the measured values \vec{x}ᵢ representing points in the k-dimensional space. The measured values \vec{x}ᵢ of the state are then fed to a Kalman filter for estimating the state of the body. For each number n of measured values \vec{x}ᵢ of a state of the body, a first quantity \vec{m}ₙ and a second quantity rₙ are derived, and are fed to the Kalman filter, the quantity \vec{m}ₙ being the center vector, and the quantity rₙ being the radius of a k-dimensional sphere Bₙ within which all points \vec{x}ᵢ are situated.

### BACKGROUND AND SUMMARY OF THE INVENTION

This application claims the priority of German patent document 10 2007 002 672.4, filed Jan. 18, 2007, the disclosure of which is expressly incorporated by reference herein.

The invention relates to a method of determining the physical state of a body.

For the control of vehicles, for example, motor vehicles and airplanes, electronic systems are increasingly used to supplement or partially replace direct control by the driver or pilot. Examples of such systems are found in antilock systems (ABS) and electronic vehicle stabilization (ESP).

Likewise, robots, whose control is increasingly taken over by electronic systems, are used in manufacturing processes, for example, in the automobile industry or for placement of components on printed circuit boards.

Furthermore, the state of a vehicle or airplane or the state of a placement arm of a robot, is generally considered as the state of a body. In this definition, a body is a moving object, such as a vehicle (for example, a landcraft), an airplane, or an insertion arm of a robot which is suitable for taking up certain states.

The state of a body also includes its position, speed, attitude or additional physical quantities, and is therefore generally defined by physical quantities which can be measured by means of technical devices. Thus, the state of a body can also be characterized by the measurement of pressure, temperature or humidity.

For carrying out their function, systems such as mentioned above require knowledge of the actual state that is as precise and reliable as possible. For example, in the case of an airplane, in the simplest case, the state is characterized by its position, speed and orientation angle. The state of a surface mounted device can in the simplest case be represented by the position of the robot arm. Depending on the modeling expenditures, the state may comprise additional physical (that is, measurable) quantities. Since some relevant state variables are not accessible for simple measurement, they partly must be estimated by means of models. In this case, the estimates can be coordinated by comparison with measured values of observable quantities. However, it is problematic that the modeled processes within the vehicle, or the position of a robot arm, as well as the measurement of the control quantities are subject to noise. Furthermore, some processes within the system to be observed are described by non-linear functions, so that their modeling requires considerable computing expenditures.

International Patent Document WO/1997/011334 A1 describes a navigation system for a vehicle which has a Kalman filter for estimating corrections for the navigation parameters and calibrating the sensors of the navigation system, and additional systems are known, for example, from European Patent Document EP 1 564 097 A1 or German Patent Document DE 10 2005 012 456 A1.

These known systems supply point quantities in a k-dimensional space as a measurement. A first group of such systems is characterized by measuring processes in which each measuring result is illustrated by a point in a multidimensional space. A plurality of measuring results, as they occur, for example, in the course of a series of measurements, is then illustrated by a point cluster in a k-dimensional space. The individual points may also particularly represent measuring errors (that is, deviations of the measuring results from a known true value). A second group is formed by processes in which, for the purpose of scanning a k-dimensional space, this space is covered by a discrete k-dimensional grid. Those grid points (in the case of a two-dimensional image processing, also pixels) at which the space to be scanned has a certain defined characteristic, are combined to a point quantity.

An example of the first group is the high-frequency recording of air data of an airplane consisting of the static pressure and the dynamic pressure, or the angle of attack and the angle of yaw. Each measurement results in a point in a two-dimensional space. Naturally, further air data may be added, whereby the dimension of the space is increased.

Terrain Reference Navigation (TRN) process is an example of the second group. Here, the two-dimensional horizontal plane or the three-dimensional space is searched for points at which a predefined minimum number of contour lines overlap. Surface-mounted device (SMD) placing machines represent another example of the second group, in which printed circuit boards are to be equipped with components at defined positions (that is, at points of the two-dimensional plane).

To estimate the state, the point quantity is conventionally transmitted to a Kalman filter. However, this creates the disadvantage that the individual measurements, which are represented by the point quantity, are generally considerably noise-infested, and because of the data quantity to be processed by the Kalman filter, an output of the estimated state that is close with respect to the time is therefore not possible.

One object to the invention is to provide a method which can achieve a reduction of the noise, and can provide a precise estimation of the state in real time.

This and other objects and advantages are achieved by the method according to the invention, in which a number n of measured values \vec{x}ᵢ of a state of a body are recorded, expediently by sensors which generate signals indicative of the measured state.

A first quantity \vec{m}ₙ and a second quantity rₙ are computed according to the invention for each number n of measured values \vec{x}ᵢ of a state of a body. (In this context, measured values \vec{x}ᵢ include not only raw data but also those values which have been processed inside or outside a measuring device.) The computed quantities \vec{m}ₙ and rₙ are fed to the Kalman filter for estimating the state of the body and are further processed there, in which case the quantity \vec{m}ₙ is the center and the quantity rₙ is the radius of a k-dimensional sphere Bₙ, within which all points \vec{x}ᵢ of the measurements of the respective state are situated. Because a large number n of measuring points are combined in the sphere Bₙ, the noise of the center \vec{m}ₙ is clearly suppressed with respect to the noise of the individual measuring points \vec{x}ᵢ.

By means of the process according to the invention, the center and the radius are determined for a k-dimensional sphere that is as small as possible and which, without exception, contains all points \vec{x}ᵢ, i=1, . . . , n of the measured point quantity. This sphere is described by its k-dimensional center \vec{m}ₙ and its radius rₙ.

These parameters are fed to a Kalman filter, which estimates an overall state of the body to be examined, based on the series of measurements of the states of the individual sensors.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an example of a two-dimensional distribution of a series of measurements of measuring points \vec{x}ᵢ of the state of a body;

FIG. 2 is a view of a process for obtaining starting values \vec{m}₀ and r₀ for a first further development of the invention;

FIG. 3 is a view of an alternative process for obtaining starting values \vec{m}₀ and r₀ for a second further development of the invention;

FIG. 4 is a view of the result of an optimization shown as an example;

FIG. 5a is a view of the time sequence of TRN position measurements shown as an example;

FIG. 5b is a view of the time sequence of measurements of an inertia sensor shown as an example.

### DETAILED DESCRIPTION OF THE DRAWINGS

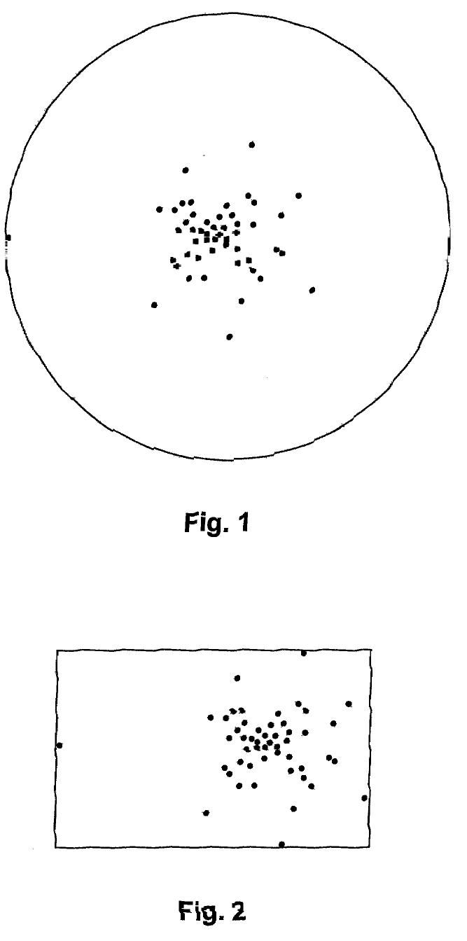

In the process according to the invention, from a mathematical point of view, the smallest sphere is determined which encloses the entire point quantity {\vec{x}ᵢ, i=1, . . . , n}. This is the optimization of a (k+1)-dimensional quantity under n secondary conditions. Specifically, the k+1 quantities (\vec{m}ₙ, rₙ) are to be determined such that the radius rₙ becomes minimal under the secondary conditions that |\vec{x}ᵢ-\vec{m}ₙ|≦rₙ for all i=1, . . . , n. In this case, |\vec{x}ᵢ-\vec{m}ₙ| indicates the geometrical spacing of the two points \vec{x}ᵢ and \vec{m}ₙ in the k-dimensional space. FIG. 1 is a view of an example of a two-dimensional distribution of measuring points \vec{x}ᵢ.

In a first further embodiment of the invention, the process is divided into two steps: the first step being used to obtain starting values \vec{m}₀, r₀ for the subsequent optimization (second step).

To obtain the starting values, the minimal coordinate kₘᵢₙ_{_{—}}_{y} and the maximal coordinate kₘₐₓ_{_{—}}_{y} of all points \vec{x}ᵢ is determined in each of the k-dimensions. In this manner, the minimal k-dimensional cuboid is determined which contains all points \vec{x}ᵢ (compare FIG. 2). The center vector of the thus obtained k-dimensional cuboid is called \vec{m}₀. Of the k edge lengths of the cuboid, the longest one is selected and half of the latter is called r₀.

Starting from the center \vec{m}₀ and the radius r₀, the subsequent optimization is advantageously recursively carried out as follows:

It is assumed that the sphere around the center \vec{m}ₙ with the radius r₀ already contains all points \vec{x}ᵢ, with i≦v; that is, it is assumed that the relation |\vec{x}ᵢ-\vec{m}ᵥ |≦rᵥ has already been met for all i=1, . . . , v. If the relation |\vec{x}ᵥ₊₁-\vec{m}ᵥ|≦rᵥ also applies, \vec{m}ᵥ₊₁=mᵥ and rᵥ₊₁=rᵥ will be set. Otherwise, mᵥ₊₁=α·mᵥ+β·\vec{x}ᵥ₊₁ and rᵥ₊₁=α·51 \vec{x}ᵥ₊₁-\vec{m}ᵥ| will be set, the coefficients α and β being defined by

$$α = \frac{1}{2} \cdot ( 1 + \frac{{r}_{v}}{\vert {\vec{x}}_{v + 1} - {\vec{m}}_{v} \vert} ) and β = \frac{1}{2} \cdot ( 1 - \frac{{r}_{v}}{\vert {\vec{x}}_{v + 1} - {\vec{m}}_{v} \vert} )$$

By repeating the optimization step from v=0 to v=n, a sphere around the center \vec{m}ₙ with the radius rₙ is finally obtained which encloses all points \vec{x}ᵢ, i=1, . . . , n of the point quantity and meets all secondary conditions (FIG. 4).

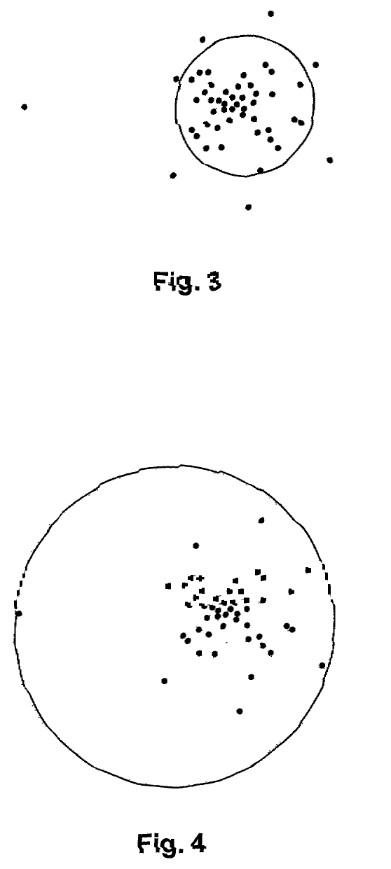

In a second further embodiment of the invention, the average value \vec{μ} and the standard deviation σ of the point quantity \vec{x}ᵢ are determined for obtaining the starting values \vec{m}₀, r₀. This alternative possibility of obtaining starting values is shown in FIG. 3. In this case, the average value is computed according to

$$\vec{μ} = \frac{1}{n} \cdot {\sum }_{i = 1}^{n} {\vec{x}}_{i}$$

and the standard deviation is computed according to

$$σ = \sqrt{\frac{1}{n} \cdot {\sum }_{i = 1}^{n} {\vert {\vec{x}}_{i} - \vec{μ} \vert}^{2}} or σ = \sqrt{\frac{1}{n - 1} \cdot {\sum }_{i = 1}^{n} {\vert {\vec{x}}_{i} - \vec{μ} \vert}^{2}} .$$

The starting values for the following optimization are defined as follows: \vec{m}₀=\vec{μ} and r₀=σ.

The further recursive determination of the optimal center \vec{m}ₙ and of the radius rₙ is obtained from the optimization steps as described above in the first further development of the invention.

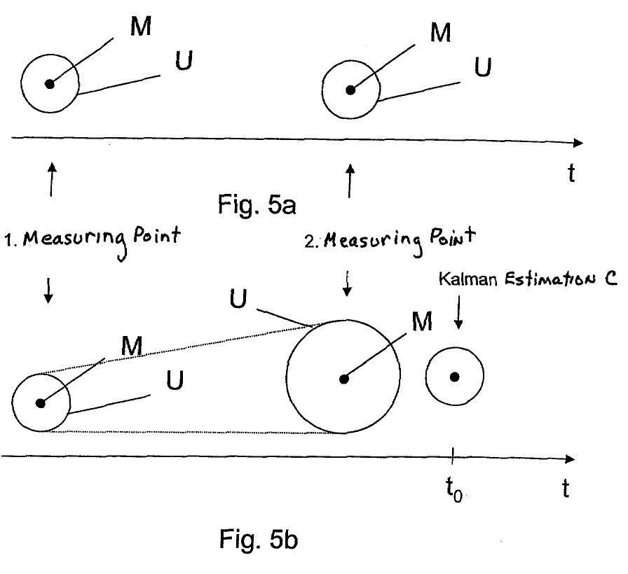

The invention will be explained below by means of a first example. The state determination and navigation of missiles is conventionally based on the use of inertia systems, in which acceleration and rotational speed data are continuously measured by inertial sensors (acceleration sensors and rotational speed sensors), and are used to determine positions, speeds and orientation angles of the missile. It is known, however, that a state determination or navigation which is based exclusively on inertia systems has the disadvantage that the errors of the thus obtained state variables grow over time, becoming increasingly less precise, and finally useless. This is illustrated in FIG. 5b where point M indicates the state (for example, the position) and circle U represents the inaccuracy of this state. At a later point in time (farther toward the right on the time scale), the inaccuracy has increased.

To avoid such a continuous deterioration of the accuracy, additional sensors or processes, such as satellite navigation or Terrain Referenced Navigation (TRN), are used with the inertial systems.

FIG. 5a illustrates schematically the determination of the state of the body by means of such an additional process. It is characteristic that the precision does not systematically deteriorate as time progresses. However, in contrast to an inertia system, the data are, as a rule, not continuously present.

It is known that the data supplied by the different sensors and processes can be combined in a Kalman filter, which uses an error model to determine an optimal estimated value from the present data, which is generally more precise than the result of the individual sensors. In this manner, the defects of a pure inertia navigation are eliminated. This is illustrated in FIG. 5b in that, by using the data of the additional sensor or process from FIG. 5a, the inaccuracy built up as a result of the inertia navigation (compare second circle in FIG. 5b) is reduced again (compare third circle in FIG. 5b).

The invention can now be used, for example, in the case of the Terrain Referenced Navigation (TRN) at the interface to the Kalman filter. In TRN, a spatial area is determined which contains the two- or three-dimensional position of the missile with a certain probability. By the quantization of the spatial area, the TRN outputs a two- or three-dimensional point quantity. This point quantity is to be further processed in an integrated navigation system in real time, for which a Kalman filter is typically used. However, the Kalman filter expects a position (center) and a dimension (radius) as standard-type input variables. The described process is capable of processing the point quantity supplied by the TRN such that subsequent Kalman filtering becomes possible in real time.

The invention can therefore be used in a navigation system in which data of the TRN are merged with data of an inertia system to form navigation signals in a Kalman filter. Additional data (for example, from satellite navigation signals) may flow into the Kalman filter.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A method for determining the physical state of a body, said method comprising:
measuring and recording of a number n of values \vec{x}ᵢ of physical quantities that characterize the state of the body, with i=1, . . . , n, the measured values \vec{x}ᵢ representing points in the k-dimensional space; and
feeding the measured values \vec{x}ᵢ to a Kalman filter for estimating the state of the body; wherein,
for each number n of measured values \vec{x}ᵢ, a first quantity \vec{m}ₙ and a second quantity rₙ are derived, the quantity \vec{m}ₙ being a center vector, and the quantity rₙ being a radius of a k-dimensional sphere Bₙ within which all points \vec{x}ᵢ are situated, with i=1, . . . , n; and
the derived quantities \vec{m}ₙ and rₙ are fed to the Kalman filter for determining the sate of the body.

2. The method according to claim 1, wherein the center \vec{m}ₙ and the radius rₙ are determined in a recursion step starting from starting values \vec{m}₀ and r₀;
it is assumed that the relation |\vec{x}ᵢ-\vec{m}ᵥ|≦rᵥ has been met for all i≦v;
if |\vec{x}ᵥ₊₁-\vec{m}ᵥ|≦rᵥ also applies, \vec{m}ᵥ₊₁=mᵥ and rᵥ₊₁=rᵥ will be set;
otherwise, \vec{m}ᵥ₊₁=α·\vec{m}ᵥ+β·\vec{x}ᵥ₊₁ and rᵥ₊₁=α·|\vec{x}ᵥ₊₁-\vec{m}ᵥ| will be set, in which
$$α = \frac{1}{2} \cdot ( 1 + \frac{{r}_{v}}{\vert {\vec{x}}_{v + 1} - {\vec{m}}_{v} \vert} ) and β = \frac{1}{2} \cdot ( 1 - \frac{{r}_{v}}{\vert {\vec{x}}_{v + 1} - {\vec{m}}_{v} \vert} ) ;$$
and the recursion step is repeated for v=0, . . . , n.

3. The method according to claim 2, wherein:
the starting values \vec{m}₀ o and r₀ are defined by determining a k-dimensional cuboid from the minimal coordinates kₘᵢₙ_{_{—}}_{y} and the maximal coordinates kₘₐₓ_{_{—}}_{y} with y=1, . . . , k of all points \vec{x}ᵢ in the k dimensions; and
a k-dimensional sphere is determined, with radius r₀ and center \vec{x}₀, \vec{m}₀ being the center vector of the k-dimensional cuboid and r₀ being half of the longest section from the quantity of coordinate pairs kₘᵢₙ_{_{—}}_{y} and kₘₐₓ_{_{—}}_{y} in every dimension.

4. The method according to claim 2, wherein
\vec{m}₀, r₀, the average value and the standard deviation of the point quantity {\vec{x}ᵢ, i=1, . . . , n} are selected as the starting values;
\vec{m}₀=/n·Σᵢ₌₁ⁿ\vec{x}; and
$${r}_{0} = \sqrt{\frac{1}{n} \cdot {\sum }_{i = 1}^{n} {\vert {\vec{x}}_{i} - {\vec{m}}_{0} \vert}^{2}} brz . {r}_{0} = \sqrt{\frac{1}{n - 1} \cdot {\sum }_{i = 1}^{n} {\vert {\vec{x}}_{i} - {\vec{m}}_{0} \vert}^{2}} .$$

5. A system for determining the physical state of a body, said system comprising:
a plurality of sensors which generate a number n of measured values \vec{x}ᵢ for physical quantities that are indicative of states of the body, with i=1 . . . n;
a computing device which processes the measured values of a state in each case and computes a first quantity \vec{m}ₙ and a second quantity rₙ, the quantity \vec{m}ₙ being a center point vector and the quantity rₙ being a radius of a k-dimensional sphere Bₙ within which all points \vec{x}ᵢ with i=1, . . . , n are situated; and
a Kalman filter which is coupled to the computing device to receive the computed first and second quantities, which are processed therein to generate an output that is indicative of the physical state of the body.

6. The system according to claim 5, wherein the sensors comprise at least one of inertia sensors, Terrain Referenced Navigation, radar altimeters, Doppler radars, air data sensors, satellite navigation receivers and sensors for the determination of yaw angle, inclination angle or tilting angle.

7. The method according to claim 1, wherein the physical state comprises at least one of i) position, altitude or speed of the body, ii) pressure, temperature and iii) humidity.
